(19) United States
(12) Patent Application Publication
(10) Pub. No.: US 2017/0202076 A1
(43) Pub. Date: Jul. 13, 2017

(54) LIGHTING APPARATUS AND LIGHTING SYSTEM

(71) Applicant: Panasonic Intellectual Property Management Co., Ltd., Osaka (JP)

(72) Inventor: Shinichiro KURIHARA, Osaka (JP)

(21) Appl. No.: 15/401,268

(22) Filed: Jan. 9, 2017

(30) Foreign Application Priority Data
Jan. 12, 2016 (JP) 2016-003942

(51) Int. Cl. H05B 37/02; H05B 33/08

(52) U.S. Cl. CPC H05B 37/0272; H05B 33/0845; H05B 33/0863

(57) ABSTRACT

Lighting apparatuses each include an apparatus communicator and an apparatus controller. The apparatus communicator wirelessly transmits and receives information on operations of the lighting apparatuses. The apparatus controller interprets: a mesh profile which is a communications protocol for the lighting apparatus to transmit and receive the information to and from another lighting apparatus and a communication terminal forming a mesh network, and a user profile which is a communications protocol for the lighting apparatus and the communication terminal to communicate with each other, the user profile being uniquely set for the lighting apparatus by the communication terminal, and executes a command corresponding to the mesh profile and received from the other lighting apparatus, and a command corresponding to the user profile and received from the communication terminal.

### CROSS REFERENCE TO RELATED APPLICATION

This application claims the benefit of priority of Japanese Patent Application Number 2016-003942 filed on Jan. 12, 2016, the entire content of which is hereby incorporated by reference.

### BACKGROUND

1. Technical Field

The present disclosure relates to a lighting apparatus which forms a mesh network with another lighting apparatus, and a lighting system.

2. Description of the Related Art

Conventionally, a lighting system is known in which lighting apparatuses having communications capabilities form a mesh network. The mesh network refers to a network in which the lighting apparatuses construct wireless communication paths therebetween.

As one lighting system of this kind, Japanese Unexamined Patent Application Publication No. 2014-60078 (Patent Literature 1) discloses a lighting system which includes lighting apparatuses each of which includes a wireless device, wireless terminals which communicate with the lighting apparatuses, and a management server which manages the lighting apparatuses. In the lighting system, adjacent lighting apparatuses are communicable with each other and the lighting apparatuses form a mesh network. In the lighting system, the lighting apparatuses are dimmed properly for a user who is holding one of the wireless terminals, based on location information of a user.

### SUMMARY

In the lighting system disclosed in Patent Literature 1, the management server transmits a command for dimming a lighting apparatus via other lighting apparatuses, that is, using a communication path of the mesh network. However, a problem with the mesh network is that, for example, when a lighting apparatus is no longer participating in the mesh network for some reason, it is difficult for the mesh network to cause the lighting apparatus to re-participate in the mesh network. Moreover, it is difficult for the user to directly touch and repair a lighting apparatus promptly, due to the fact that the lighting apparatus is installed on the ceiling of a building or the temperature of the lighting apparatus has been increased through use.

Thus, the present disclosure provides a lighting apparatus, etc. which increase communication paths for the lighting apparatus to wirelessly communicate with another lighting apparatus, and allow the lighting apparatus to select a proper communication path according to need among the communication paths.

One aspect of the lighting apparatus according to the present disclosure includes: an apparatus communicator which wirelessly transmits and receives information on operation of the lighting apparatus; and an apparatus controller which interprets a mesh profile which is a communications protocol for the lighting apparatus to transmit and receive the information to and from another lighting apparatus and a communication terminal forming a mesh network, and a user profile which is a communications protocol for the lighting apparatus and the communication terminal to communicate with each other, the user profile being uniquely set for the lighting apparatus by the communication terminal, and executes a command corresponding to the mesh profile and received from the other lighting apparatus, and a command corresponding to the user profile and received from the communication terminal.

One aspect of a lighting system according to the present disclosure includes a plurality of the lighting apparatuses.

Communication paths for the lighting apparatus to wirelessly communicate with another lighting apparatus can be increased and the lighting apparatus is allowed to select a proper communication path according to need among the communication paths.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a diagram illustrating a lighting system and lighting apparatuses according to Embodiment 1, showing an example of a mesh network configured of the lighting apparatuses;

FIG. 2 is a diagram illustrating an example of the appearance of the lighting apparatuses according to Embodiment 1;

FIG. 3 is a block diagram illustrating a control configuration of the lighting apparatuses according to Embodiment 1;

FIG. 4 is a block diagram of a control configuration of a communication terminal which communicates with the lighting apparatuses according to Embodiment 1;

FIG. 5 is a diagram illustrating a relationship between the mesh network and the lighting apparatuses according to Embodiment 1, showing (a) a state in which a certain lighting apparatus is not participating in the mesh network, (b) a state in which the lighting apparatus not participated in the mesh network is communicating with the communication terminal, and (c) a state in which the lighting apparatus has re-participated in the mesh network;

FIG. 6 is a flowchart illustrating a manner of causing the lighting apparatus not participating in the mesh network to participate in the mesh network;

FIG. 7 is a block diagram of a control configuration of lighting apparatuses according to Embodiment 2; and

FIG. 8 is a diagram illustrating relationship between a mesh network and the lighting apparatuses according to Embodiment 2, showing (a) a state in which a certain lighting apparatus is participating in the mesh network, (b) a state in which the lighting apparatus is reset through communication paths of the mesh network, and (c) a relationship between the mesh network and the lighting apparatus restored to a default state.

### DETAILED DESCRIPTION OF THE EMBODIMENTS

Hereinafter, a lighting apparatus and a lighting system according to embodiments of the present disclosure are described with reference to the accompanying drawings. The embodiments described below are each merely one specific example of the present disclosure. Thus, values, shapes, materials, components, and arrangement and connection between the components shown in the following embodiments are merely by way of illustration and not intended to limit the present disclosure. Therefore, among the components in the embodiments below, components not recited in any one of the independent claims defining the most generic part of the inventive concept of the present disclosure are described as arbitrary components.

The figures are schematic views and do not necessarily illustrate the present disclosure precisely. In the figures, the same reference sign is used to refer to substantially the same configuration, and thus duplicate description is omitted or simplified.

### Embodiment 1

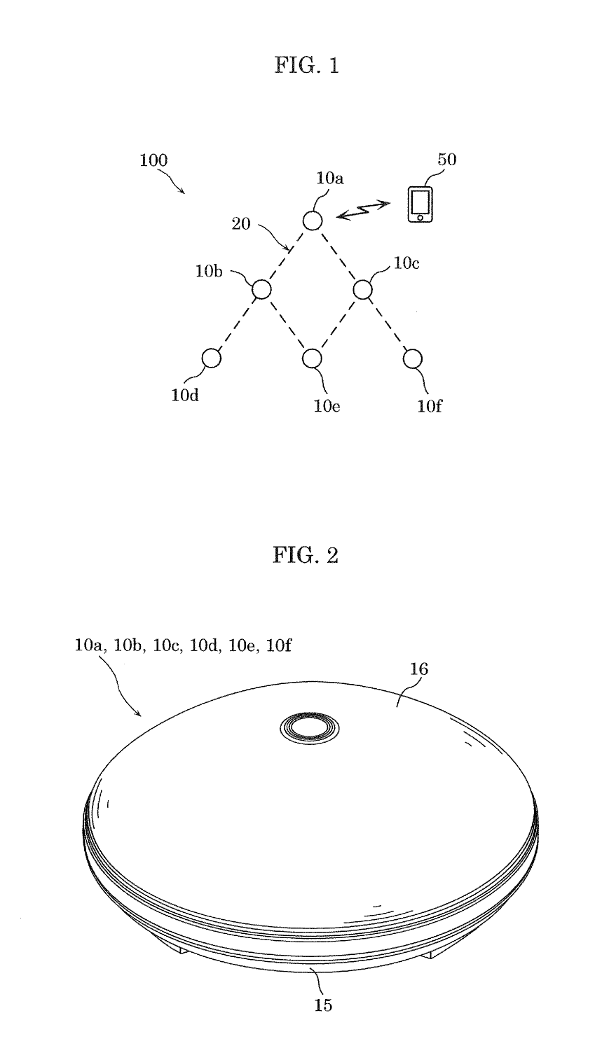

FIG. 1 is a diagram illustrating lighting system 100 and lighting apparatuses 10a, 10b, 10c, 10d, 10e, and 10f according to Embodiment 1, showing an example of mesh network 20 which includes lighting apparatuses 10a to 10f.

Lighting system 100 includes lighting apparatuses 10a to 10f having communications capabilities. In lighting system 100, adjacent lighting apparatuses (e.g., lighting apparatuses 10c and 10f), among lighting apparatuses 10a to 10f, communicate with each other to construct a wireless communication path therebetween and form mesh network 20. Lighting apparatuses 10a to 10f are also communicatively coupled with communication terminal 50 such as a tablet.

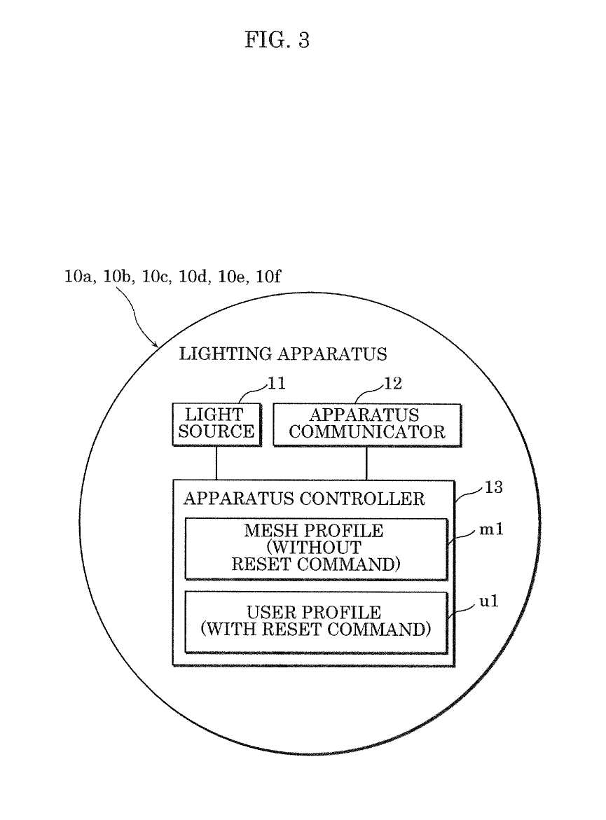

FIG. 2 is a diagram illustrating an example of the appearance of each of lighting apparatuses 10a to 10f. FIG. 3 is a block diagram of a control configuration of each of lighting apparatuses 10a to 10f.

Lighting apparatuses 10a to 10f are, for example, ceiling lights as illustrated in FIG. 2, and installed in a building part (e.g., ceiling) of a building such as a house. Lighting apparatuses 10a to 10f each include apparatus body 15 and globe 16 which covers apparatus body 15. Globe 16 is formed of a light-transmissive resin material. Apparatus body 15, as illustrated in FIG. 3, includes light source 11, apparatus communicator 12, and apparatus controller 13.

Light source 11, for example, includes light-emitting diodes each of which emits white light, red light, green light, or blue light. Dimming and a color of the light emitted by light source 11 are controlled by apparatus controller 13.

Apparatus communicator 12 includes an antenna and a wireless communication circuit. Apparatus communicator 12 included in a lighting apparatus wirelessly transmits and receives information on operations of lighting apparatuses 10a to 10f to and from another lighting apparatus. For example, lighting apparatus 10c is communicable with lighting apparatuses 10a, 10e, and 10f located adjacent to lighting apparatus 10c. The communications are performed according to a communication scheme in which the communications are performed in 2.4-GHz frequency band, such as Bluetooth (registered trademark) specified in IEEE802.15.1 standard. Apparatus communicators 12 included in lighting apparatuses 10a to 10f are communicable with communication terminal 50 as well.

Apparatus controller 13 includes, for example, a CPU, a RAM, and a ROM storing a program. In the present embodiment, apparatus controller 13 has mesh profile m1 and user profile u1. Mesh profiles m1 are communications protocols for lighting apparatuses 10a to 10f to transmit and receive signals to and from another lighting apparatus and communication terminal 50. Lighting apparatuses 10a to 10f form mesh network 20. User profiles u1 are communications protocols for lighting apparatuses 10a to 10f and communication terminal 50 to communicate with each other. User profile u1 is uniquely set for each lighting apparatus by communication terminal 50.

Mesh profile m1 includes authentication information including an address assigned for each of lighting apparatuses 10a to 10f and a cryptographic key for the network. In apparatus controller 13, the authentication information including the address and cryptographic key is deletable or modifiable.

Mesh profiles m1 also include commands for controlling operations of lighting apparatuses 10a to 10f, the operations including the dimming, color controlling, scenes, and schedules of light sources 11 included in lighting apparatuses 10a to 10f. Lighting apparatuses 10a to 10f are each operated according to a command corresponding to mesh profile m1. The command corresponding to mesh profile m1 is transmitted from communication terminal 50 via a communication path of mesh network 20. For example, lighting apparatus 10a receives, by apparatus communicator 12, the command corresponding to mesh profile m1 and transmitted from communication terminal 50, and causes apparatus controller 13 to execute the command corresponding to mesh profile m1. At the same time, lighting apparatus 10a causes apparatus communicator 12 to transmit to lighting apparatuses 10b and 10c located adjacent to lighting apparatus 10a, the command corresponding to mesh profile m1 that has been transmitted to lighting apparatus 10a.

It should be noted that lighting apparatuses 10a to 10f according to the present embodiment each receive not only the information but also a command corresponding to user profile u1 and transmitted from communication terminal 50 via the communication path of mesh network 20. Lighting apparatus 10a to 10f each cause apparatus controller 13 to execute the command corresponding to user profile u1 and received by apparatus communicator 12.

For example, the commands corresponding to user profiles u1 include reset commands which initialize configurations of lighting apparatuses 10a to 10f to cause lighting apparatuses 10a to 10f to be ready to participate in mesh network 20.

In contrast, the commands corresponding to mesh profiles m1 do not include the reset commands which initialize the configurations of lighting apparatuses 10a to 10f to cause lighting apparatuses 10a to 10f to be ready to participate in mesh network 20. For that reason, lighting apparatuses 10a to 10f can be reset directly by communication terminal 50 by using user profiles u1, but are not reset indirectly by using mesh profiles m1. This reduces chances of inadvertent resetting of lighting apparatuses 10a to 10f.

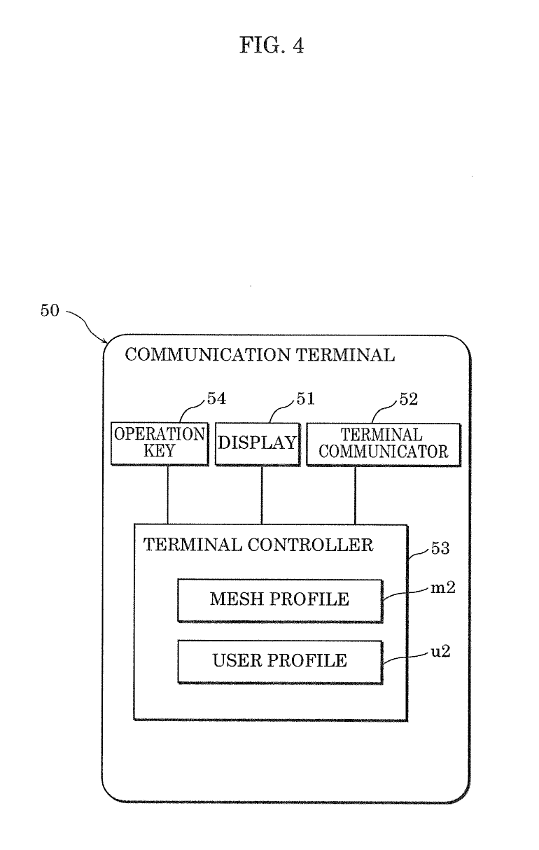

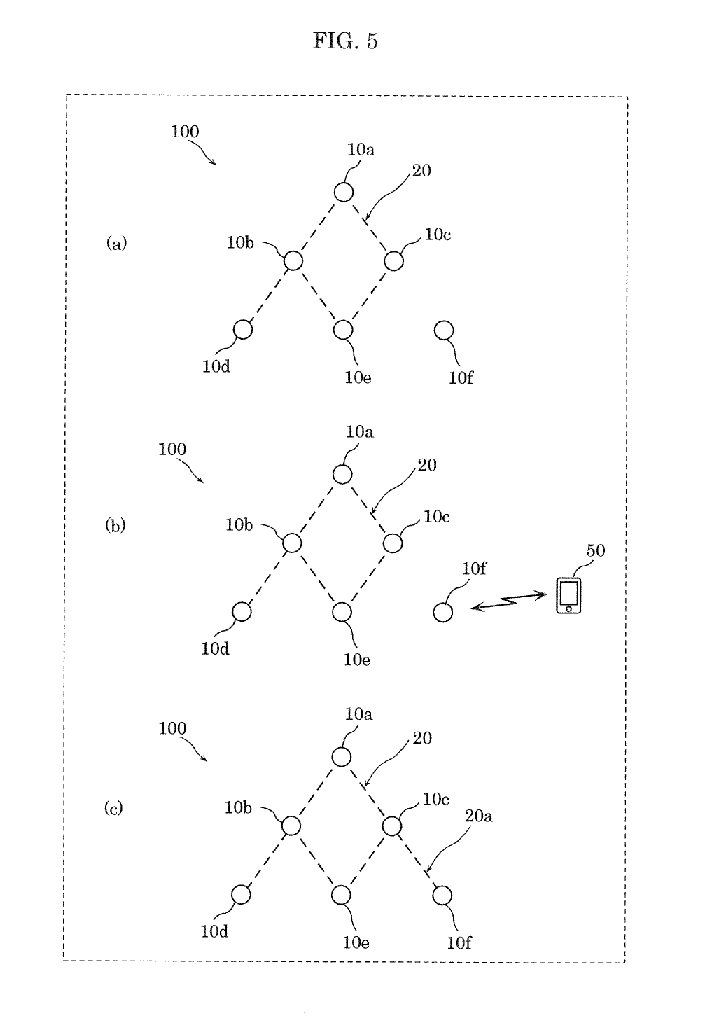

FIG. 4 is a block diagram of a control configuration of communication terminal 50 which communicates with lighting apparatuses 10a to 10f.

Communication terminal 50 includes operation key 54, display 51, terminal communicator 52, and terminal controller 53.

Operation key 54 is, for example, a touch panel for selecting or inputting commands for operating lighting apparatuses 10a to 10f. Display 51 is, for example, a liquid crystal monitor for displaying states of individual lighting apparatuses 10a to 10f and as to whether they are participating or not participating in mesh network 20.

Terminal communicator 52 includes an antenna and a wireless communication circuit. Terminal communicator 52 is communicable with lighting apparatuses 10a to 10f that are within a predetermined distance. Terminal communicator 52 communicates with lighting apparatuses 10a to 10f at a frequency different from the frequency of mesh network 20, using a communication scheme which is, for example, Bluetooth (registered trademark).

Terminal controller 53 includes, for example, a CPU, a RAM, and a ROM. Terminal controller 53 has mesh profile m2 and user profile u2. Mesh profile m2 is a communications protocol and has functionality common to mesh profiles m1 of lighting apparatuses 10a to 10f. User profile u2 is a communications protocol and has functionality common to user profiles u1 of lighting apparatuses 10a to 10f.

Mesh profile m2 includes authentication information including an address assigned for each of lighting apparatuses 10a to 10f and a cryptographic key for the network. The authentication information including the address and cryptographic key can be input via operation key 54. Mesh profile m2 also includes commands for controlling operations of lighting apparatuses 10a to 10f, the operations including the dimming, color controlling, scenes, and schedules of light sources 11 included in lighting apparatuses 10a to 10f. Communication terminal 50 can operate individual lighting apparatuses 10a to 10f, based on the commands included in mesh profile m2.

The commands corresponding to user profiles u2 include reset commands which initialize configurations of individual lighting apparatuses 10a to 10f to cause lighting apparatuses 10a to 10f to be ready to participate in mesh network 20.

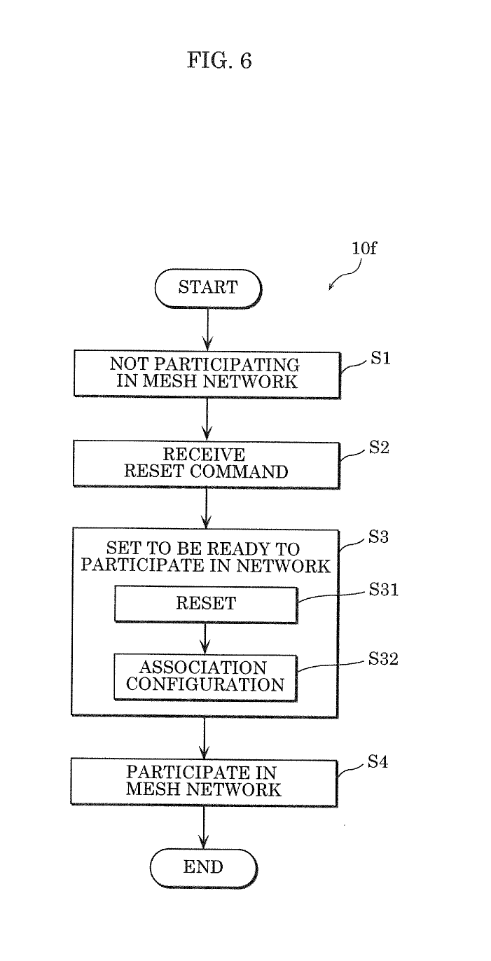

Next, referring to FIGS. 5 and 6, a method for causing lighting apparatus 10f not participating in mesh network 20 to re-participate in mesh network 20 is described.

FIG. 5 illustrates (a) a state in which lighting apparatus 10f is not participating in mesh network 20, (b) a state in which lighting apparatus 10f not participated in mesh network 20 is communicating with communication terminal 50, and (c) a state in which lighting apparatus 10f has re-participated in mesh network 20. FIG. 6 is a flowchart illustrating a manner of causing lighting apparatus 10f not participating in mesh network 20 to participate in mesh network 20.

As illustrated in (a) of FIG. 5, if the cryptographic key of lighting apparatus 10f among lighting apparatuses 10a to 10f is unintentionally modified for some reason, lighting apparatus 10f may end up not participating in mesh network 20 and thus no longer form part of mesh network 20 (S1 of FIG. 6). Since lighting apparatus 10f is already disconnected from mesh network 20, even though lighting apparatus 10f is desired to participate in mesh network 20, mesh network 20 itself cannot restore the communication path for lighting apparatus 10f to cause lighting apparatus 10f to participate in mesh network 20.

Thus, as illustrated in (b) of FIG. 5, lighting apparatus 10f is caused to participate in mesh network 20 through a communication path between communication terminal 50 and lighting apparatus 10f. Initially, communication terminal 50 transmits to lighting apparatus 10f the reset command corresponding to user profile u1. This results in lighting apparatus 10f receiving the reset command (S2 of FIG. 6).

Lighting apparatus 10f having received the reset command sets the configuration of lighting apparatus 10f to be ready to participate in the network (S3 of FIG. 6). Specifically, initially, the current configuration of lighting apparatus 10f is reset (initialized) (S31 of FIG. 6). The resetting deletes the information on the operation of lighting apparatus 10f, and the authentication information, including the address and cryptographic key, which is stored in apparatus controller 13 included in lighting apparatus 10f.

Next, association configuration (configuration to participate in mesh network 20) is carried out on lighting apparatus 10f having been reset (S32 of FIG. 6). Specifically, apparatus communicator 12 included in lighting apparatus 10f sends out a beacon for externally notifying that lighting apparatus 10f needs association configuration. It should be noted that lighting apparatus 10f is in a full-on state while sending out the beacon.

When communication terminal 50 receives the beacon sent out from lighting apparatus 10f, communication terminal 50 displays, on display 51, an indication indicating that lighting apparatus 10f is requesting for association configuration, and obtains, from the beacon, a unique device identifier (UDID) of lighting apparatus 10f. Communication terminal 50 then performs a predetermined operation, and thereby transmits to lighting apparatus 10f the authentication information (such as an address and a cryptographic key) for causing lighting apparatus 10f to participate in mesh network 20, using the command corresponding to user profile u2. The authentication information is associated with the UDID.

Lighting apparatus 10f having received the authentication information executes the command corresponding to user profile u1, the authentication information including the address and cryptographic key is written to apparatus controller 13. This restores the configuration of lighting apparatus 10f to the default state which is a configuration state of lighting apparatus 10f when previously participated in mesh network 20. Lighting apparatus 10f restored to the default state ceases from sending out the beacon.

Then, as illustrated in (c) of FIG. 5, communication path 20a is formed between lighting apparatus 10f and lighting apparatus 10c adjacent to lighting apparatus 10f, and lighting apparatus 10f participates in mesh network 20 (S4 FIG. 6). Lighting apparatus 10f participating in mesh network 20 is operated and controlled, using the command corresponding to mesh profile m1.

As described above, lighting apparatuses 10a to 10f according to the present embodiment each include: apparatus communicator 12 which wirelessly transmits and receives information on operations of lighting apparatuses 10a to 10f; and apparatus controller 13 which has: mesh profile m1 which is a communications protocol for lighting apparatuses 10a to 10f to transmit and receive the information to and from another lighting apparatus and communication terminal 50, each of lighting apparatuses 10a to 10f and the other lighting apparatus forming mesh network 20; and user profile u1 which is a communications protocol for each of lighting apparatuses 10a to 10f and communication terminal 50 to communicate with each other, user profile u1 being uniquely set for each of lighting apparatuses 10a to 10f by communication terminal 50. Apparatus controller 13 executes a command corresponding to mesh profile m1 and received from the other lighting apparatus, and a command corresponding to user profile u1 and received from communication terminal 50.

According to the above configuration, in order to operate a certain lighting apparatus (e.g., lighting apparatus 10f), options are selectable between either operating the lighting apparatus by using mesh profile m1 common to mesh profiles m1 of the other lighting apparatuses (e.g., lighting apparatuses 10a to 10e) or operating the lighting apparatus by using user profile u1 common to user profile u2 included in communication terminal 50. This allows a proper communication path to be selected according to need for wireless communications with lighting apparatuses 10a to 10f. Moreover, even when lighting apparatuses 10a to 10f are installed on the ceiling of a building or the temperatures thereof have been increased through use, lighting apparatuses 10a to 10f can be restored to the default states via wireless communications.

Moreover, the commands corresponding to user profiles u1 may include reset commands for initializing configurations of lighting apparatuses 10a to 10f to cause lighting apparatuses 10a to 10f to be ready to participate in mesh network 20, and the command corresponding to mesh profile m1 may not include the reset command.

According to the above configuration, when resetting the certain lighting apparatus (e.g., lighting apparatus 10f), the other lighting apparatuses (e.g., lighting apparatuses 10a to 10e) are not reset through communication paths of mesh network 20. This results in reducing chances of inadvertent resetting of the other lighting apparatuses.

Moreover, when lighting apparatus 10f is disconnected from and no longer forming part of mesh network 20 with the other lighting apparatus, apparatus controller 13 may cause lighting apparatus 10f no longer forming part of mesh network 20 to participate in mesh network 20 by using the command corresponding to user profile u1.

This allows directly restoring the lighting apparatus (e.g., lighting apparatus 10f) disconnected from mesh network 20 to the default state by using communication terminal 50 having user profile u2, and causing the lighting apparatus to re-participate in mesh network 20.

Moreover, lighting system 100 according to the present embodiment includes lighting apparatuses 10a to 10f. According to the above configuration, in order to operate a certain lighting apparatus (e.g., lighting apparatus 10f) included in lighting system 100, options are selectable between either operating the lighting apparatus by using mesh profile m1 common to the other lighting apparatuses (e.g., lighting apparatuses 10a to 10e) or operating the lighting apparatus by using user profile u1 common to communication terminal 50. This allows a proper communication path to be selected according to need for wireless communications with lighting apparatuses 10a to 10f included in lighting system 100.

### Embodiment 2

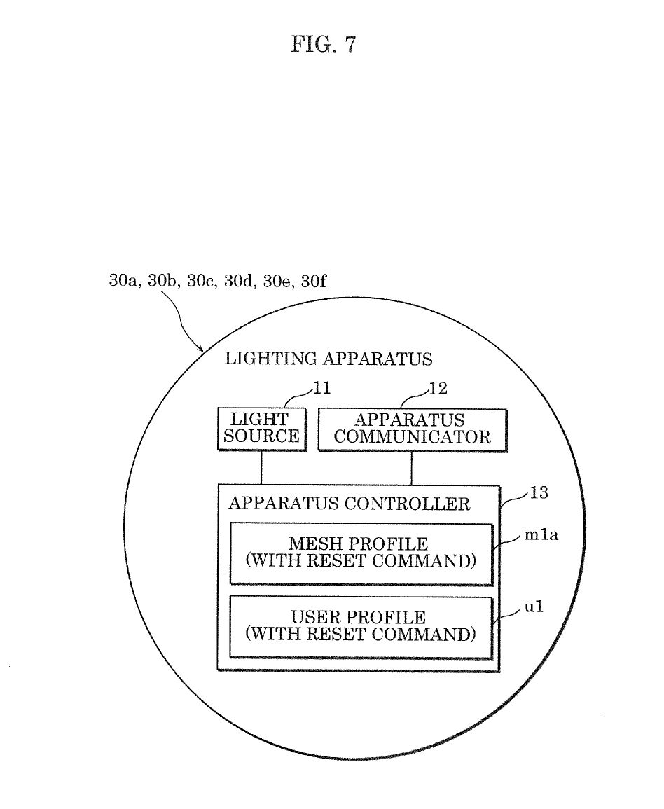

Lighting apparatuses 30a, 30b, 30c, 30d, 30e, and 30f (FIG. 7) according to Embodiment 2 are each given a command from another lighting apparatus through a communication path of mesh network 20, rather than being given the command directly from communication terminal 50.

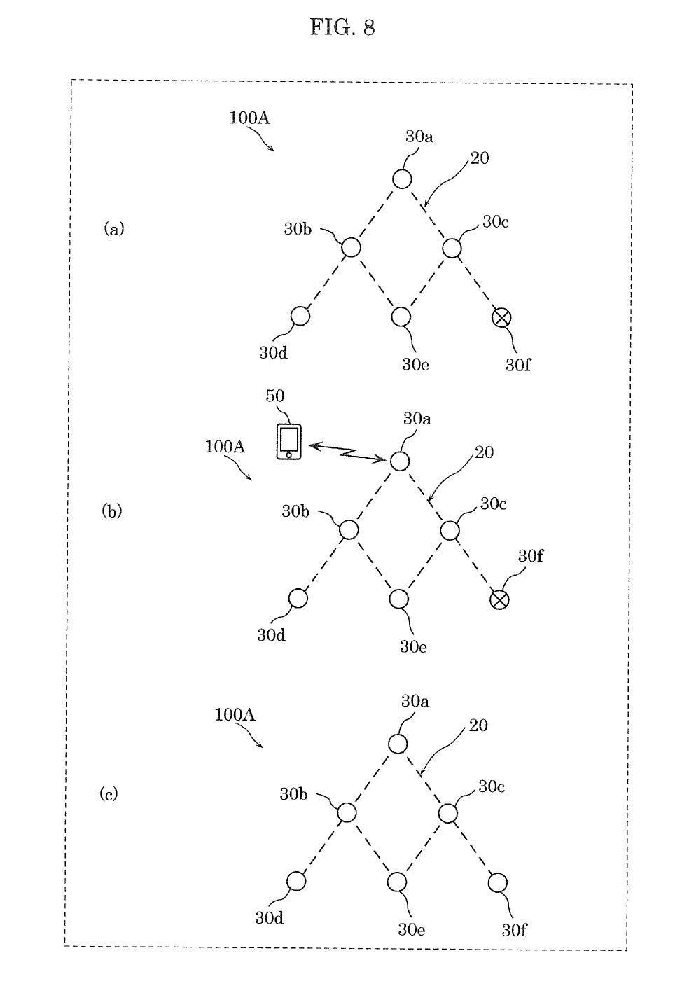

Lighting system 100A according to Embodiment 2 includes lighting apparatuses 30a to 30f which have communications capabilities (see (a) of FIG. 8). In lighting system 100A, adjacent lighting apparatuses (e.g., lighting apparatuses 30b and 30d), among lighting apparatuses 30a to 30f, communicate with each other to construct a wireless communication path therebetween and form mesh network 20. Lighting apparatuses 30a to 30f are also communicatively coupled with communication terminal 50 such as a tablet.

FIG. 7 is a block diagram of a control configuration of lighting apparatuses 30a to 30f.

Lighting apparatuses 30a to 30f each include light source 11, apparatus communicator 12, and apparatus controller 13. Apparatus controller 13 has mesh profile m1a and user profile u1. Mesh profiles m1a are communications protocols for lighting apparatuses 30a to 30f to transmit and receive signals to and from communication terminal 50. Lighting apparatuses 30a to 30f form mesh network 20. User profiles u1 are communications protocols for lighting apparatuses 30a to 30f and communication terminal 50 to communicate with each other. User profile u1 is uniquely set for each lighting apparatus by communication terminal 50.

Mesh profiles m1a include authentication information including addresses assigned for lighting apparatuses 30a to 30f and a cryptographic key for the network.

Mesh profiles m1a also include commands for controlling operations of lighting apparatuses 30a to 30f, the operations including the dimming, color controlling, scenes, and schedules of light sources 11 included in lighting apparatuses 30a to 30f.

Lighting apparatuses 30a to 30f are each operated according to a command corresponding to mesh profile m1a. The command corresponding to mesh profile m1a is transmitted from communication terminal 50 via a communication path of mesh network 20.

Lighting apparatuses 30a to 30f according to the present embodiment have commands corresponding to mesh profiles m1a and commands corresponding to user profiles u1, the commands corresponding to mesh profiles m1a and the commands corresponding to user profiles u1 including reset commands which set the configurations of lighting apparatuses 30a to 30f to default states. It should be noted that the default state refers to a configuration state for each of lighting apparatuses 30a to 30f when previously participated in mesh network 20.

Similar to as shown in FIG. 4, communication terminal 50 includes operation key 54, display 51, terminal communicator 52, and terminal controller 53.

Terminal controller 53 has mesh profile m2 and user profile u2. Mesh profile m2 is a communications protocol and has functionality common to mesh profiles m1a of lighting apparatuses 30a to 30f. User profile u2 is a communications protocol and has functionality common to user profiles u1 of lighting apparatuses 30a to 30f. To be more specific, commands corresponding to mesh profiles m2 and user profiles u2 include the reset commands which set the configurations of lighting apparatuses 30a to 30f to the default states.

Lighting apparatuses 30a to 30f according to the present embodiment each receive, by apparatus communicator 12, not only the information but also a command corresponding to user profile u1 via the communication path of mesh network 20. The command corresponding to user profile u1 is transmitted from communication terminal 50. Lighting apparatus 10a to 10f each cause apparatus controller 13 to execute the command corresponding to user profile u1.

In the present embodiment, however, not only the commands corresponding to user profiles u1 but also the commands corresponding to mesh profiles m1a include the reset commands which set the configurations of lighting apparatuses 30a to 30f to the default states. For that reason, for example, by transmitting the reset command to nearby lighting apparatus 30a, communication terminal 50 can set distant lighting apparatus 30f to the default state using the reset command included in mesh profile m1a included in lighting apparatus 30f.

Next, referring to FIG. 8, a method for resetting lighting apparatus 30f participating in mesh network 20 is described.

FIG. 8 illustrates (a) a state in which lighting apparatus 30f is participating in mesh network 20, (b) a state in which lighting apparatus 30f is reset through communication paths of mesh network 20, and (c) a relationship between mesh network 20 and lighting apparatus 30f restored to the default state.

As illustrated (a) of FIG. 8, lighting apparatus 30f among lighting apparatuses 30a to 30f may, for some reason, perform an operation unintended by a user. “Operation unintended by a user,” as used herein, refers to a case, for example, where the light of lighting apparatus 30a is different in intensity or color from those of lighting apparatuses 30a to 30e. If lighting apparatus 30f is near communication terminal 50, lighting apparatus 30f can be reset to be restored to the default state directly by using communication terminal 50 as described above in relation to Embodiment 1. If lighting apparatus 30f is distant from communication terminal 50, the user needs to move communication terminal 50 to a location close to lighting apparatus 30f. This is laborious and time-consuming.

Thus, as illustrated in (b) of FIG. 8, lighting apparatus 30f is reset to the default state, using a communication path of mesh network 20. Initially, communication terminal 50 transmits the reset command included in mesh profile m1a to lighting apparatus 30a. The reset command is transferred to lighting apparatus 30f via lighting apparatus 30a and lighting apparatus 30c forming mesh network 20. To be more specific, lighting apparatus 30f receives the reset command included in mesh profile m1a via lighting apparatuses 30a and 30c that are different from lighting apparatus 30f.

Lighting apparatus 30f having received the reset command sets the configuration of lighting apparatus 30f to the default state. Specifically, the current configuration (dimming, color controlling, etc.) of lighting apparatus 30f is set to the default state. It should be noted that the address and cryptographic key stored in apparatus controller 13 included in lighting apparatus 30f are retained without being deleted.

This allows the operation of lighting apparatus 30f restored to the default state to be controlled again, as with lighting apparatuses 30a to 30e, using the command corresponding to mesh profile m1a as illustrated in (c) of FIG. 8,.

It should be noted that in order to reset lighting apparatus 30f, the address and cryptographic key stored in apparatus controller 13 included in lighting apparatus 30f may be deleted. Even after the address and cryptographic key are deleted, communication terminal 50 can restore lighting apparatuses 30a to 30f to the default states by associating with lighting apparatuses 30a to 30f through exchanging public keys and thereafter assigning lighting apparatuses 30a to 30f with addresses and cryptographic keys. Moreover, as with S32 in FIG. 6 in Embodiment 1, the association configuration can be carried out on lighting apparatus 30f, using user profile u2 of communication terminal 50.

As described above, lighting apparatuses 30a to 30f according to the present embodiment each include: apparatus communicator 12 which wirelessly transmits and receives information on operations of lighting apparatuses 30a to 30f; and apparatus controller 13 which has: mesh profile m1a which is a communications protocol for lighting apparatuses 30a to 10 to transmit and receive the information to and from another lighting apparatus and communication terminal 50, each of lighting apparatuses 30a to 10 and the other lighting apparatus forming mesh network 20; and user profile u1 which is a communications protocol for each of lighting apparatuses 30a to 30f and communication terminal 50 to communicate with each other, user profile u1 being uniquely set for each of lighting apparatuses 30a to 30f by communication terminal 50. Apparatus controller 13 executes a command corresponding to mesh profile m1a and received from the other lighting apparatus, and a command corresponding to user profile u1 and received from communication terminal 50.

According to the above configuration, in order to operate a certain lighting apparatus (e.g., lighting apparatus 30f), options are selectable between operating the lighting apparatus by using mesh profile m1a common to mesh profiles m1 of the other lighting apparatuses (e.g., lighting apparatuses 30a to 30e) or operating the lighting apparatus by using user profile u1 common to communication terminal 50. This allows a proper communication path to be selected according to need for wireless communications with lighting apparatuses 30a to 30f. Moreover, even when lighting apparatuses 30a to 30f are installed on the ceiling of a building or the temperatures thereof have been increased through use, lighting apparatuses 30a to 30f can be restored to the default states via wireless communications.

Moreover, the command corresponding to mesh profile m1a and the command corresponding to user profile u1 may include reset commands for changing configurations of lighting apparatuses 30a to 30f to the default states.

According to the above configuration, the certain lighting apparatus (e.g., lighting apparatus 30f) can be reset not only by using the command corresponding to user profile u1, but also by using the command corresponding to mesh profile m1a, thereby allowing an increase in options for resetting lighting apparatuses 30a to 30f.

Moreover, apparatus communicator 12 may receive from the other lighting apparatus the reset command corresponding to mesh profile m1a, and apparatus controller 13 may execute the reset command corresponding to mesh profile m1a.

According to this configuration, for example, distant lighting apparatus 30f can be restored to the default state using the reset command corresponding to mesh profile m1a included in lighting apparatus 30f, by transmitting the reset command to lighting apparatus 30a.

While the present embodiment has been described with reference to restoring lighting apparatus 30f to the default states with reference to FIG. 8, the present embodiment is not limited thereto. For example, the present disclosure may be used to restore lighting apparatus 30a to the default state when lighting apparatus 30a participating in mesh network 20 does not conform with lighting apparatuses 30b to 30f in terms of dimming or color controlling.

While lighting apparatuses 10a to 10f, 30a to 30f and lighting system 100, 100A have been described with reference to the embodiments, the present disclosure is not limited to the above embodiments. For example, various modifications to the embodiments according to the present disclosure described above that may be conceived by a person skilled in the art and embodiments implemented by any combination of the components and functions shown in the above embodiments are also included within the scope of the present disclosure, without departing from the spirit of the present disclosure.

For example, while lighting apparatuses 10a to 10f are operated by commands included in communication terminal 50 in Embodiment 1, the present disclosure is not limited thereto. Lighting system 100 may include a management server which manages lighting apparatuses 10a to 10f and the management server may operate lighting apparatuses 10a to 10f by commands corresponding to a mesh profile of the management server.

Moreover, while mesh profile m2 of terminal controller 53 does not include the reset command in Embodiment 1, the present disclosure is not limited thereto. Mesh profile m2 of terminal controller 53 may include the reset command. Since the reset commands corresponding to mesh profiles m1 are not executed in lighting apparatuses 10a to 10f in Embodiment 1, there is no problem with transmitting the reset command according to mesh profile m2 of terminal controller 53.

Moreover, while Embodiment 1 has been described with reference to a mesh network being formed of adjacent lighting apparatuses (e.g., lighting apparatuses 10c and 10f), the present disclosure is not limited thereto. The mesh network may be formed between lighting apparatuses 10a to 10f equivalent to a predetermined number of hops within the range of wirelessly communication.

Moreover, while Embodiments 1 and 2 have been described with reference to Bluetooth (registered trademark) as the communication scheme, the present disclosure is not limited thereto. A communication scheme such as WiFi (registered trademark), infrared communications, Wi-SUN, or Zigbee may be used.

Moreover, while Embodiment 1 has been described with reference to lighting apparatuses 10a to 10f being ceiling lights, the present disclosure is not limited thereto. Lighting apparatuses 10a to 10f may be LED base lights or LED down lights, or other types of lighting without departing from the intended scope of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A lighting apparatus comprising:
an apparatus communicator which wirelessly transmits and receives information on operation of the lighting apparatus; and
an apparatus controller which
interprets a mesh profile which is a communications protocol for the lighting apparatus to transmit and receive the information to and from another lighting apparatus and a communication terminal forming a mesh network, and a user profile which is a communications protocol for the lighting apparatus and the communication terminal to communicate with each other, the user profile being uniquely set for the lighting apparatus by the communication terminal, and
executes a command corresponding to the mesh profile and received from the other lighting apparatus, and a command corresponding to the user profile and received from the communication terminal.

2. The lighting apparatus according to claim 1, wherein
the command corresponding to the user profile includes a reset command for initializing a configuration of the lighting apparatus to cause the lighting apparatus to be ready to participate in the mesh network, and
the command corresponding to the mesh profile does not include the reset command.

3. The lighting apparatus according to claim 2, wherein
when the lighting apparatus is disconnected from and no longer forming the mesh network with the other lighting apparatus, the apparatus controller causes the lighting apparatus no longer forming the mesh network to participate in the mesh network by using the command corresponding to the user profile.

4. The lighting apparatus according to claim 1, wherein
the command corresponding to the mesh profile and the command corresponding to the user profile include a reset command for changing a configuration of the lighting apparatus to a default state.

5. The lighting apparatus according to claim 4, wherein
the apparatus communicator receives from the other lighting apparatus the reset command corresponding to the mesh profile, and the apparatus controller executes the reset command corresponding to the mesh profile.

6. A lighting system comprising
a plurality of the lighting apparatuses, each including:
an apparatus communicator which wirelessly transmits and receives information on operation of the lighting apparatus; and
an apparatus controller which
interprets a mesh profile which is a communications protocol for the lighting apparatus to transmit and receive the information to and from another lighting apparatus among the plurality of lighting apparatuses and a communication terminal forming a mesh network; and a user profile which is a communications protocol for the lighting apparatus and the communication terminal to communicate with each other, the user profile being uniquely set for the lighting apparatus by the communication terminal, and
executes a command corresponding to the mesh profile and received from the other lighting apparatus, and a command corresponding to the user profile and received from the communication terminal.

7. The lighting system according to claim 6, wherein
the command corresponding to the user profile includes a reset command for initializing a configuration of the lighting apparatus to cause the lighting apparatus to be ready to participate in the mesh network, and
the command corresponding to the mesh profile does not include the reset command.

8. The lighting system according to claim 7, wherein
when the lighting apparatus is disconnected from and no longer forming the mesh network with the other lighting apparatus, the apparatus controller causes the lighting apparatus no longer forming the mesh network to participate in the mesh network by using the command corresponding to the user profile.

9. The lighting system according to claim 6, wherein
the command corresponding to the mesh profile and the command corresponding to the user profile include a reset command for changing a configuration of the lighting apparatus to a default state.

10. The lighting system according to claim 9, wherein
the apparatus communicator receives from the other lighting apparatus the reset command corresponding to the mesh profile, and the apparatus controller executes the reset command corresponding to the mesh profile.
